(19) United States
(12) Patent Application Publication
(10) Pub. No.: US 2008/0211793 A1
(43) Pub. Date: Sep. 4, 2008

(54) Driving apparatus for an OLED panel

(76) Inventor: Chiung-Ching Ku, Zhubei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/007,272

(22) Filed: Jan. 9, 2008

(30) Foreign Application Priority Data
Jan. 12, 2007 (TW) 096101329

(51) Int. Cl. G06F 3/038

(52) U.S. Cl. 345/204

(57) ABSTRACT

A driving apparatus for an OLED panel comprises a common timing controller with a multi-line addressing algorithm and a segment controller with the multi-line addressing algorithm, to control a common driver and a segment driver, respectively, to drive the OLED panel. The common driver and the segment driver are connected to common lines and segment lines of the OLED panel, respectively. According to the multi-line addressing algorithm, the common driver can select at least two of the common lines at a same time.

### FIELD OF THE INVENTION

The present invention is related generally to an organic light-emitting diode (OLED) display and, more particularly, to a driving apparatus for an OLED panel.

### BACKGROUND OF THE INVENTION

OLED display is more advantageous than other flat panel displays (FPD); for example, it consumes lower power, has higher brightness, is more easily manufactured, and does not need backlight etc. The market share of the OLED display is gradually increasing with the OLED technique more and more developed. For illustration, here is provided a simplified OLED display with four common lines and three segment lines as shown in FIG. 1, in which a traditional OLED display 100 comprises a driving apparatus 102 to drive an OLED panel 104. The OLED panel 104 comprises a plurality of OLEDs D1-D12, and resistors Rc1-Rc16 and Rs1-Rs12 connected between segment lines a, b and c and common lines A, B, C and D. In the driving apparatus 102, a common timing controller 106 provides common signals com1, com2, com3 and com4 for a common driver 112 having switches 1122, 1124, 1126 and 1128 connected to the common lines A, B, C and D, respectively, the common signals com1, com2, com3 and com4 control the switches 1122, 1124, 1126 and 1128 to sequentially connect the common lines A, B, C and D to ground GND, a segment controller 108 provides segment signals seg1, seg2 and seg3 for a segment driver 110 having current sources 1102, 1104 and 1106 connected to the segment lines a, b and c, and the segment signals seg1, seg2 and seg3 control the current sources 1102, 1104 and 1106 to provide currents Is1, Is2 and Is3 to the panel 104.

FIG. 2 shows a timing diagram for the circuit of FIG. 1, in which block 200 represents the segment signals seg1-seg3, waveform 202 represents the common signal com1, waveform 204 represents the common signal com2, waveform 206 represents the common signal com3, and waveform 208 represents the common signal com4. FIG. 3 shows a detail circuit of the common driver 112 of FIG. 1, in which each of the switches 1122-1128 is composed of a NMOS transistor and a PMOS transistor connected in series between a high voltage and ground GND. In the display 100, the segment signals seg1-seg3 and the common signals com1-com4 determine which one or ones of the OLEDs D1-D12 are to be lighted. For example, as shown in FIG. 2, at time t1, the common signal com1 is low, so as to turn off the NMOS transistor MN1 and turn on the PMOS transistor MP1 in the switch 1122, and therefore the common line A is grounded. In this condition, the switch 1122 is regarded as being on. If the current source 1102 provides the current Is1 to the panel 104 during the time period t1 to t2, the current Is1 will flow from the segment line a through the OLED D10, the common line A and the PMOS transistor MP1 to ground GND, and so the OLED D10 is lighted. In the same way, if the segment signals seg2 and seg3 also control the current sources 1104 and 1106 to provide the currents Is2 and Is3 to the panel 104, the OLEDs D11 and D12 will both be lighted too. At time t2, the common signal com1 becomes high, so as to turn on the NMOS transistor MN1 and turn off the PMOS transistor MP1 in the switch 1122, and therefore the common line A is connected to a high voltage. In this condition, the switch 1122 is regarded as being off, and so the currents Is1, Is2 and Is3 can't flow from the segment lines a, b and c through the OLED D10, D11 and D12 to the switch 1122.

FIG. 4 shows the current flowing through the switch 1122 of FIG. 1 on a time base. In the traditional OLED display 100, the switches 1122-1128 are turned on in turn, as shown in FIG. 2. When all the switches 1112-1128 are turned on once, it means that one frame had scanned, and as shown in FIG. 2, this time period of from time t1 to time t3 is also called a frame period. In one frame period, as shown in FIGS. 2 and 4, the switch 1122, for example, is turned on during time t1 to time t2 to allow current to flow therethrough. In order to light up an OLED, the current flowing through the OLED must reach a preset amount during time t1 to time t2, for example 100 mA. A display of higher resolution requires its common driver to have more switches for the more common lines. Generally speaking, the frame period is fixed, and therefore the on-time of each of the switches in the common driver of a display of higher resolution will reduce since the number of the switches increases. Hence, the operating voltage is required to be higher to raise the current flowing through the OLED to achieve the preset amount. When the duty is bigger and bigger, the current peak is higher and higher. The high current peak will damage the OLED panel and reduce the lifetime of the panel. Moreover, the consumed power will increase when the current peak increases.

### SUMMARY OF THE INVENTION

An object of the present invention is to provide a driving apparatus for an OLED penal, which can reduce the power of the OLED panel and increase the lifetime of the OLED panel.

According to the present invention, a driving apparatus for an OLED panel comprises a common timing controller and a segment controller both with a multi-line addressing (MLA) algorithm, and a common driver and a segment driver controlled by the common timing controller and the segment controller, respectively, to drive the OLED panel. The common driver and the segment driver are connected to a plurality of common lines and a plurality of segment lines of the OLED panel, respectively. The common driver includes a plurality of switches, each connected to one of the plurality of common lines of the OLED panel, and a sink digital-to-analog controller to provide a plurality of common signals to select at least two of the plurality of common lines at a same time according to a signal provided by the common timing controller, so as to increase the on-time of each of the plurality of switches, and therefore to reduce the current peak of the OLED panel, and as a result, to reduce the power of the OLED panel and the lifetime of the OLED panel.

### BRIEF DESCRIPTION OF THE DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows a traditional OLED display;

FIG. 2 shows a timing diagram for the circuit of FIG. 1;

FIG. 3 shows a detail structure for the common driver 112 of FIG. 1;

FIG. 4 shows the current flowing through a switch in the common driver of FIG. 1 on a time base;

FIG. 5 shows an embodiment according to the present invention;

FIG. 6 shows a waveform diagram for the circuit of FIG. 5;

FIG. 7 shows the current flowing through a switch in the common driver of FIG. 5 on a time base;

FIG. 8 shows a matrix equation in a traditional driving method;

FIG. 9 shows the produced current on a time base according to the traditional driving method of FIG. 8;

FIG. 10 shows a matrix equation in a MLA driving method;

FIG. 11 shows the produced current on a time base according to the MLA driving method of FIG. 10;

FIG. 12 shows a detail circuit for the common driver of FIG. 5; and

FIG. 13 shows a waveform diagram for the circuit of FIG. 12.

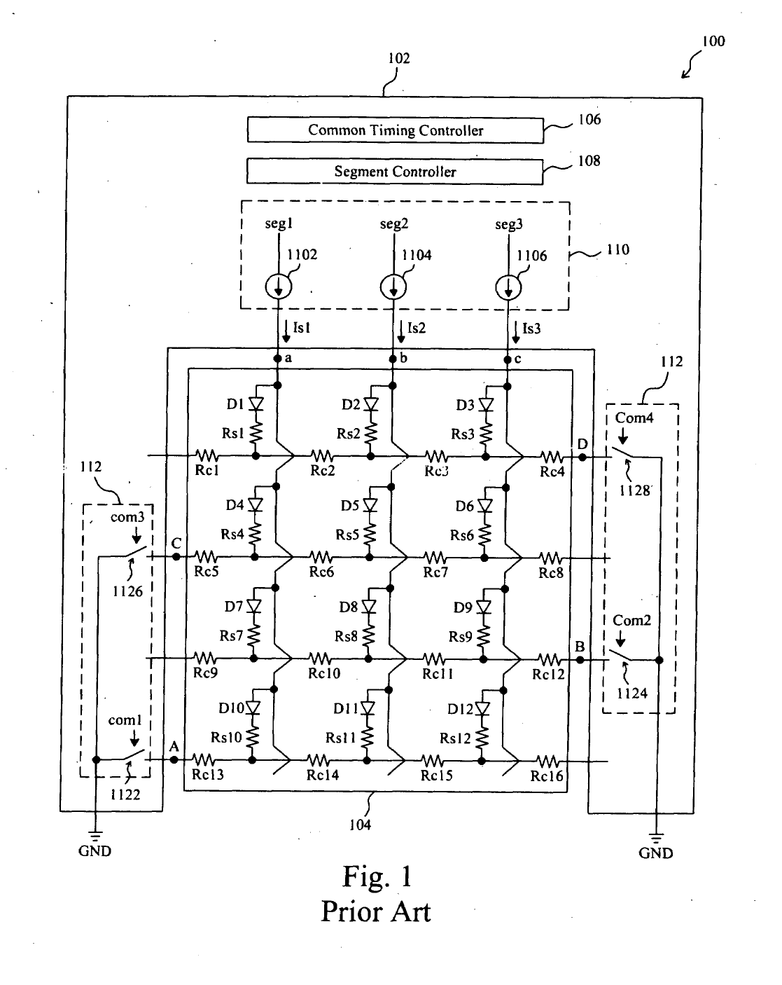

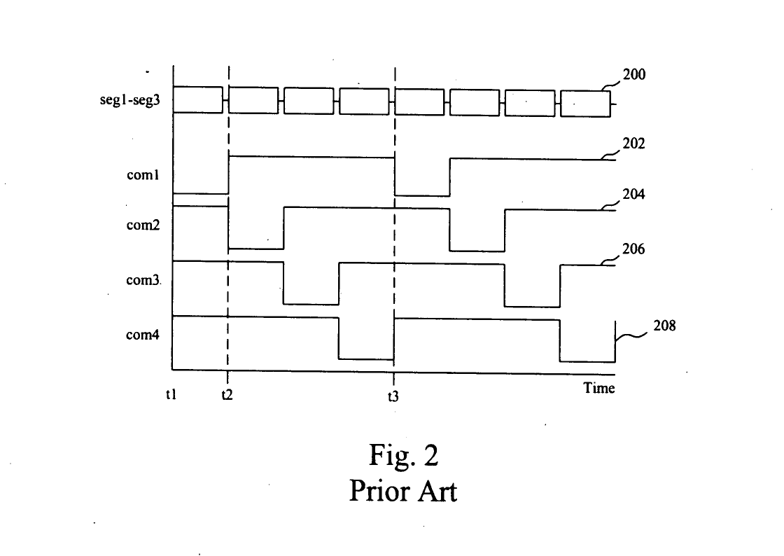

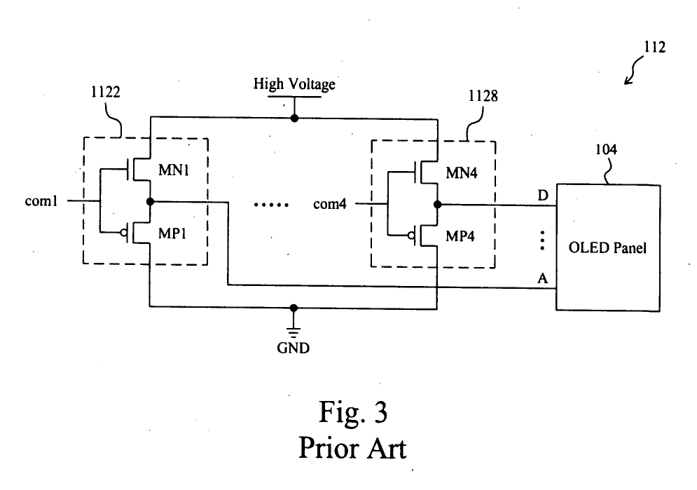

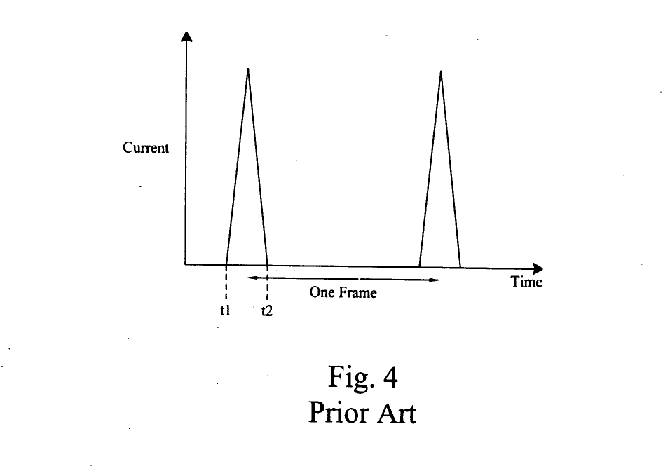

### DETAIL DESCRIPTION OF THE INVENTION

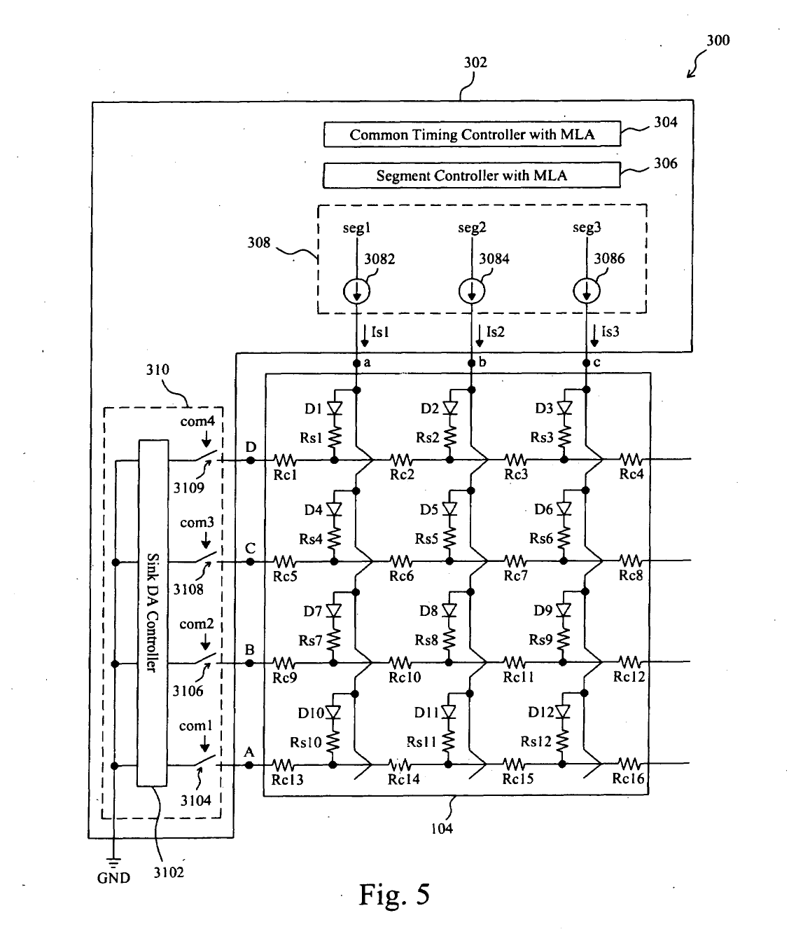

FIG. 5 shows an embodiment according to the present invention, in which an OLED display 300 comprises a driving apparatus 302 to drive an OLED panel 104. The driving apparatus 302 includes a common timing controller 304 and a segment controller 306 both with a MLA algorithm, to control a common driver 310 and a segment driver 308, respectively, to drive the OLED panel 104. The segment driver 308 includes current sources 3082, 3084 and 3086 to provide currents Is1, Is2 and Is3 to segment lines a, b and c of the OLED panel 104 according to segment signals seg1, seg2 and seg3 provided by the segment controller 306. The common driver 310 includes a sink digital-to-analog (DA) controller 3102 and switches 3104, 3106, 3108 and 3109 connected between the sink DA controller 3102 and common lines A, B, C and D, respectively. Upon a control signal, the sink DA controller 3102 provides common signals com1, com2, com3 and com4 to switch the switches 3104, 3106, 3108 and 3109, respectively. Moreover, the sink DA controller 3102 also limits the currents flowing through the switches 3104, 3106, 3108 and 3109.

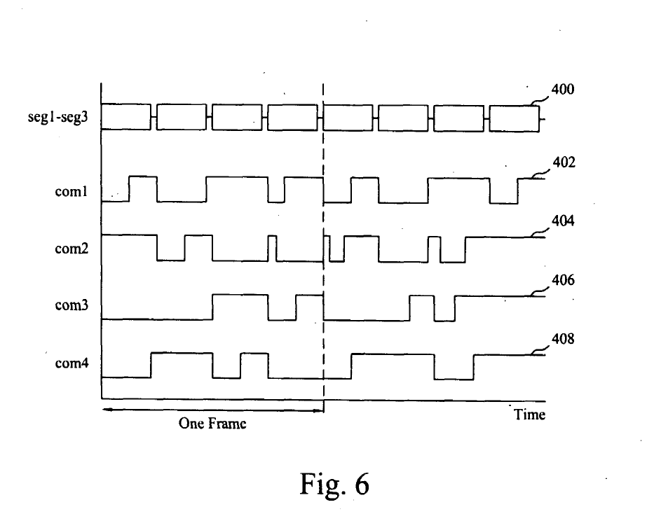

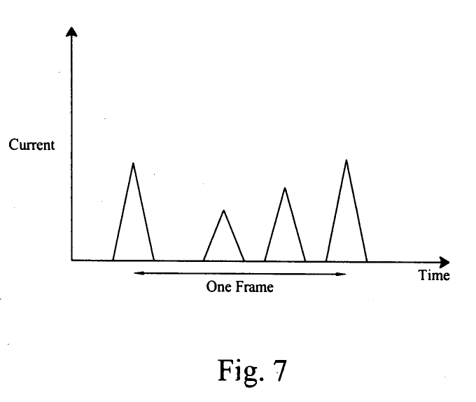

FIG. 6 shows a waveform diagram for the circuit of FIG. 5, in which block 400 represents the segment signals seg1-seg3, waveform 402 represents the common signal com1, waveform 404 represents the common signal com2, waveform 406 represents the common signal com3, and waveform 408 represents the common signal com4. According to the MLA algorithm, the common driver 310 can connect two or more of the common lines A-D to ground GND at a same time. As shown by the waveforms 402, 404, 406 and 408 of FIG. 6, in most of time, there are at least two of the common signals com1, com2, com3 and com4 are low, to turn on two or more of the switches 3104, 3106, 3108 or 3109 accordingly. The on-time of each of the switches 3104, 3106, 3108 and 3109 can vary. FIG. 7 shows the current flowing through the switch 3104 of FIG. 5 on a time base. In one frame period, the switch 3104 is turned on three times, as shown by the waveform 402 of FIG. 6. So it can obtain the produced current on a time base as shown in FIG. 7. Compared with the conventional scheme, the on-time of the switch 3104 is longer in one frame period, and therefore it has lower current peak. As a result, the power of the OLED panel 104 is reduced, and due to the lower current peak, the lifetime of the OLED panel 104 will be longer.

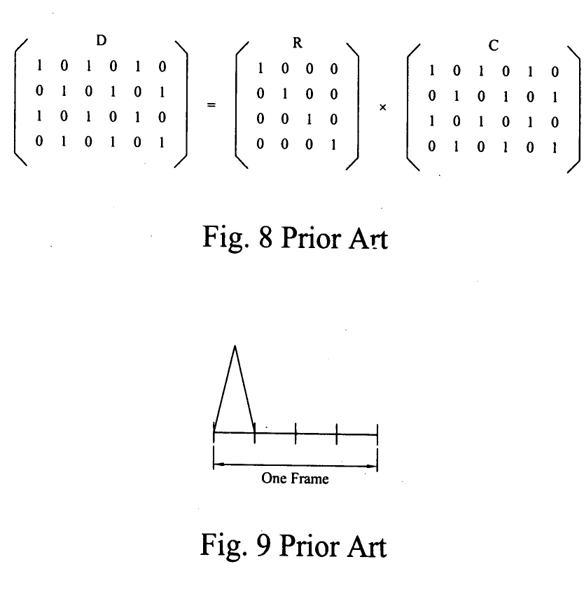

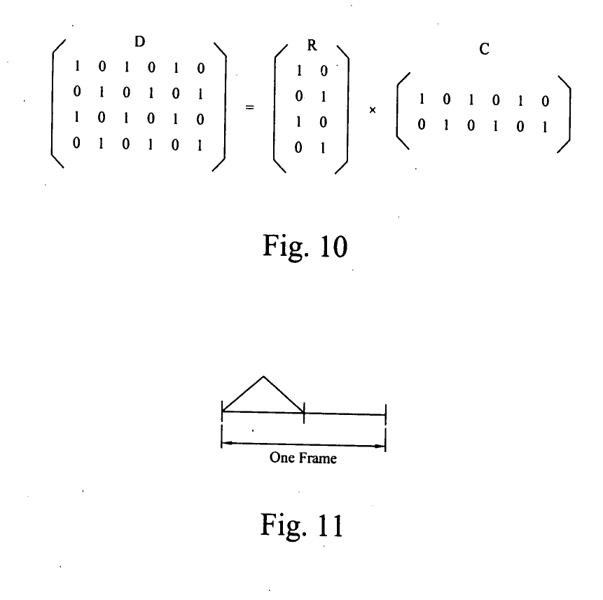

For further details about a MLA algorithm for LCD displays and OLED displays, readers are referred to U.S. patent application of publication No. 2004/150608 and European patent application of publication No. 2006/035247. For clearer illustration, matrix operation is used to picture the principles of a traditional driving method and a MLA driving method. FIG. 8 shows a matrix equation in a traditional driving method, and FIG. 9 shows the produced current in the traditional driving method of FIG. 8. FIG. 10 shows a matrix equation in a MLA driving method, and FIG. 11 shows the produced current in the MLA driving method of FIG. 10. Referring to FIGS. 8 and 10, the matrix D in the left of the equal sign represents the display image, the first matrix R in the right of the equal sign represents the common driver matrix, and the second matrix C represents the segment driver matrix. In the matrix D, “1” indicates that the OLED is lighted, and “0” indicates that the OLED is not lighted. In the matrix R, the horizontal direction indicates time, the vertical direction indicates the common signal provided by the common timing controller 304, “1” indicates that the switch is turned on, and “0” indicates that the switch is turned off. In the matrix C, the horizontal direction indicates the segment signal provided by the segment controller 306, the vertical direction indicates time, “1” indicates that the current is provided, and “0” indicates that the current isn't provided. As shown by the matrix R of FIG. 8, in a traditional driving method, the switches are always turned on in turn. Since there is only one switch turned on at each moment, the current must achieve the preset amount during a quarter frame period, as shown in FIG. 9, and therefore it needs higher operating voltage to provide the higher current. Whereas, in a MLA driving method, as shown by the matrix R of FIG. 10, there are two switches turned on at each moment, and therefore the frame period is divided into two equal parts, as shown in FIG. 11. Since the total on-time of the switch in one frame period increases, it can use lower current to light the same OLED. The current peak is lower, the required operating voltage is lower, and therefore the power is lower. Furthermore, the lower current peak can avoid damaging the OLEDs in the OLED panel, and consequently the lifetime of the OLED panel will be longer.

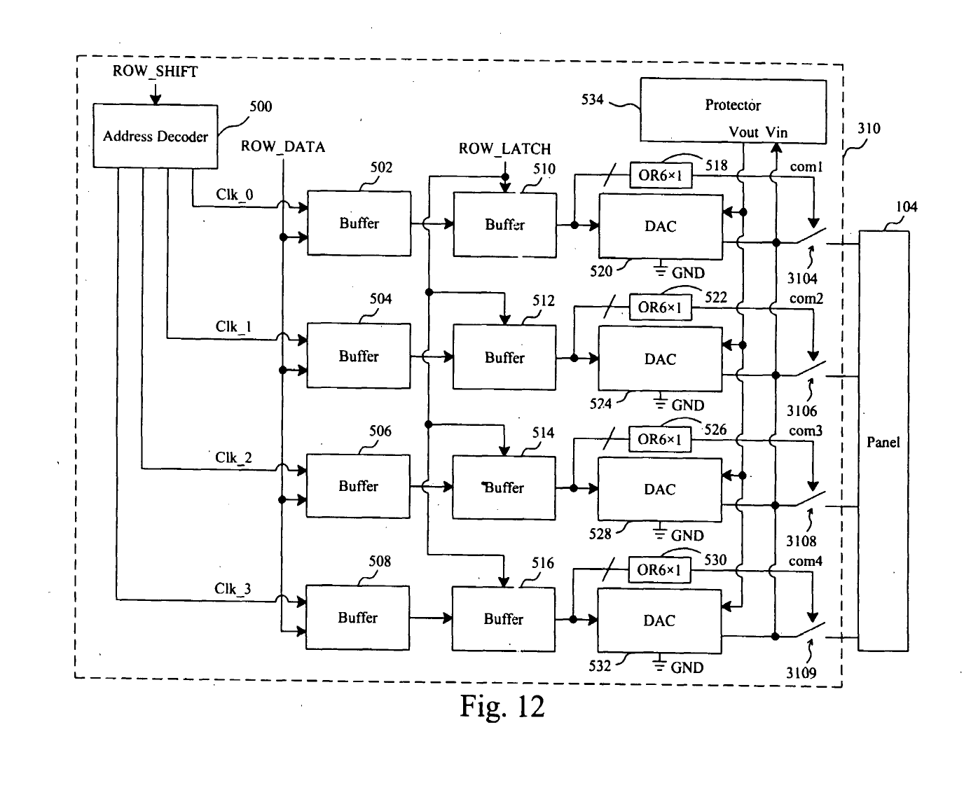

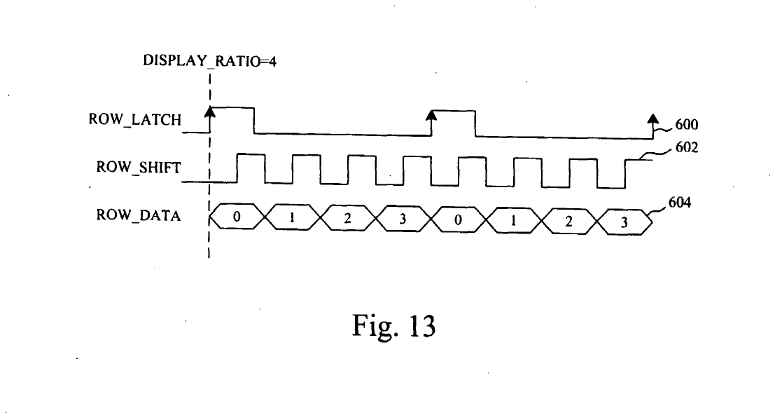

FIG. 12 shows a detail circuit for the common driver 310 of FIG. 5, and FIG. 13 shows a waveform diagram for that circuit. In FIG. 12, signals ROW_SHIFT, ROW_DATA and ROW_LATCH are provided by the common timing controller 304, in which the signal ROW_SHIFT has the waveform 602 shown in FIG. 13, the signal ROW_DATA has the waveform 604 shown in FIG. 13, and the signal ROW_LATCH has the waveform 600 shown in FIG. 13. The address decoder 500 provides clocks Clk_0-Clk_3 according to the signal ROW_SHIFT for buffers 502-508. When the clock Clk_0 transits to high, as shown by the waveform 602 of FIG. 13, data 0 in the signal ROW_DATA corresponding to the clock Clk_0 will store into the buffer 502, as shown by the waveform 604. Similarly, when the clocks Clk_1, Clk_2 and Clk_3 transit to high, data 1, data 2 and data 3 in the signal ROW_DATA corresponding to the clocks Clk_1, Clk_2 and Clk_3 will store into the buffer 504, 506 and 508, respectively. After all buffers 502-508 have stored up data, the signal ROW_LATCH will transit to high, as shown by the waveform 600 of FIG. 13, for the buffers 510-516 to read out the data in the buffers 502-508. The digital-to-analog converters 520, 524, 528 and 532 control the currents flowing through the switches 3104, 3106, 3108 and 3109 according the data in the buffers 510, 512, 514 and 516. In design, the digital-to-analog converters 520, 524, 528 and 532 can't have the currents flowing through the switches 3104, 3106, 3108 and 3109 to be zero. Therefore, to completely cut off the currents flowing through the switches 3104, 3106, 3108 and 3109, OR gates 518, 522, 526 and 530 will output the common signals corn 1, com2, com3 and com4 to completely turn off the switches 3104, 3106, 3108 and 3109. The protector 534 monitors the currents flowing through the switches 3104, 3106, 3108 and 3109, and disable the digital-to-analog converter 520, 524, 528 or 532 once the currents flowing through the switch 3104, 3106, 3108 or 3109 are too large.

While the invention has been described by way of example and in terms of the preferred embodiment, it is to be understood that the invention is not limited to the disclosed embodiments. On the contrary, it is intended to cover various modifications and similar arrangements as would be apparent to those skilled in the art. Therefore, the scope of the appended claims should be accorded the broadest interpretation to encompass all such modifications and similar arrangements.

What is claimed is:

1. A driving apparatus for an OLED panel having a plurality of segment lines and a plurality of common lines, the driving apparatus comprising:
a segment driver connected to the plurality of segment lines;
a segment controller with a multi-line addressing algorithm, for controlling the segment driver to select the plurality of segment lines;
a common driver connected to the plurality of common lines; and
a common timing controller with the multi-line addressing algorithm, for controlling the common driver to select the plurality of common lines, such that the common driver can select at least two of the plurality of common lines at a same time.

2. The driving apparatus of claim 1, wherein the segment driver comprises a plurality of current sources, each connected to one of the plurality of segment lines.

3. The driving apparatus of claim 1, wherein the common driver comprises a sink DA controller for providing a plurality of common signals to select the plurality of common lines according to a control signal provided by the common timing controller.

4. The driving apparatus of claim 3, wherein the sink DA controller limits currents flowing through the plurality of common lines according to the control signal provided by the common timing controller.

5. The driving apparatus of claim 3, wherein the common driver further comprises a plurality of switches controlled by the sink DA controller, each of the plurality of switches connected to one of the plurality of common lines.

6. The driving apparatus of claim 5, wherein the sink DA controller comprises:
a plurality of digital-to-analog converters, each connected to one of the plurality of switches for limiting a current therethrough, according to the control signal provided by the common timing controller; and
a logic circuit for switching the plurality of switches according to the control signal provided by the common timing controller.

7. The driving apparatus of claim 6, wherein the sink DA controller further comprises a protector for detecting the currents flowing through the plurality of switches to determine whether or not to disable the plurality of digital-to-analog converters.
